(19) United States
(12) Patent Application Publication
(10) Pub. No.: US 2014/0184468 A1
(43) Pub. Date: Jul. 3, 2014

(54) Integrated Radome Communications Tower

(71) Applicants: Emmett James Fitch, Dutch Harbor, AK (US); Matthew Scott, Dutch Harbor, AK (US); Jester Purtteman, Olympia, WA (US)

(72) Inventors: Emmett James Fitch, Dutch Harbor, AK (US); Matthew Scott, Dutch Harbor, AK (US); Jester Purtteman, Olympia, WA (US)

(21) Appl. No.: 14/086,964

(22) Filed: Nov. 21, 2013

Related U.S. Application Data
(60) Provisional application No. 61/729,281, filed on Nov. 21, 2012.

(51) Int. Cl. H01Q 1/42; H01Q 1/12

(52) U.S. Cl. CPC H01Q 1/42; H01Q 1/1242
USPC 343/872

(57) ABSTRACT

The invention provides a fully enclosed and modular, integrated radome communications tower capable of being helicoptered into remote locations and installed without the need for heavy equipment. The communications tower includes a radome shell that fully encloses and supports a lightweight antenna mounting system, with the shell and mounting system attached to a base to form an integrated tower. The tower can be preassembled as modular components or as a complete unit. To deliver the tower to its site of installation, it can be flown into place either modularly or as a complete unit.

### FIELD OF THE INVENTION

The present invention relates to microwave telecommunications installations.

### BACKGROUND OF THE INVENTION

Microwave communication installations have been used for years to fulfill growing telecommunication demands. Commonly used structures for accommodating microwave equipment are large lattice towers secured to the ground with pilings and concrete. Traditional towers are generally massive in order to support heavy antennas that can readily exceed 6 feet in diameter, while subject to extreme weather conditions, including icing and high winds. The latticework of these towers provides an optimal combination of readily cooled surfaces and significant surface area to promote ice buildup.

Microwave antennas installed around the world use radomes to protect signal propagation properties. These radomes are usually integrated into the antenna design. The antennas themselves are generally made of steel in order to support the weight caused from ice buildup and stresses from heavy wind-loading, as well as to meet the electrical specifications needed for microwave propagation. In remote locations, they are usually extremely large in size to increase gain, which allows for greater wireless link distances. These properties make them expensive and challenging to install, especially in extremely remote locations and even more so on mountain tops, where heavy equipment often must be delivered by helicopter.

Mountains form obstacles to microwave installations. Usually it is impractical to build a tower tall enough to get over the mountain, so it is desirable to use the mountain. Installation of a tower on a mountain can be cost prohibitive in remote locations. The current practice is to fly in heavy equipment such as backhoes and excavators, excavate a site, pour a concrete foundation from imported material, and install a traditional tower, one section at a time, with a helicopter. The associated construction equipment and unused material must then also be exported by helicopter. If the population is large enough, then a traditional tower is economically feasible. However, when the population is too small or the location too remote a traditional installation is cost prohibitive.

Due to the difficulty and expense involved in remote or mountaintop microwave communications, a more economically feasible solution is needed.

### SUMMARY OF THE INVENTION

The present invention is directed to an integrated radome communications tower having a radome shell, an antenna mounting system, and a base. The radome shell provides mechanical and load bearing support for the antenna mounting system, and further acts in combination with the base to provide support to the antenna mounting system. The integrated structure of the radome shell, antenna mounting system, and base allow for the communications tower to be lightweight. Accordingly, the entire structure, or large sections or portions thereof, is capable of being transported by helicopter into remote locations and installed without the need for heavy equipment. The tower can be installed either modularly, in sections, or as a complete unit.

The radome shell of the communications tower may be assembled from several section, or it may be constructed as a single piece. The radome shell is weather resistant and provides protection to the antenna mounting system, an antenna mounted to the antenna mounting system, and any equipment contained within the enclosed space formed by the radome shell.

The radome shell of the communications tower may extend over the entire structure of the antenna mounting system, such that the antenna mounting system is covered from its uppermost point at the top to its lowermost point at the bottom or base with the radome shell. Alternatively, the entire structure of the antenna mounting system, is covered from its uppermost point at the top to its lowermost point at the bottom or base with a protective shell, and all or a part of the protective shell is a radome. Accordingly, just part of the protective shell can be made of material that is sufficiently radiopaque to efficiently serve as a radome.

The base of the communications tower contains one or more points of attachment to anchor the base. The base may be anchored to a frame, directly to the earth or a poured foundation. Anchors such as a cable, a cemented rigid anchor, or a threaded rigid anchor, may be used to anchor the base by mechanically joining with soil, bedrock, or a combination of soil and bedrock at the site of installation of the communications tower.

### BRIEF DESCRIPTION OF THE DRAWINGS

FIG. 1 shows a side elevation view of a communications tower assembled from sectional pieces that combined create a radome frame structure and shell.

FIG. 2 shows a communications tower in which the radome shell is formed from a frame structure covered with a radio transparent material. FIG. 2A shows an overhead, cross-sectional view and FIG. 2B shows a side elevation view.

FIG. 3 shows a communications tower having a uni-structure with a solid radome shell. FIG. 3A shows an overhead, cross-sectional view and FIG. 3B shows a side elevation view.

### DETAILED DESCRIPTION OF THE INVENTION

The present invention relates to remote microwave communication installations. The sites of these installations can be very challenging, rendering the installations costly to install and maintain. In particular, it can be very costly to install and maintain installations at sites in locations with potentially extreme weather conditions or unfavorable geography.

Mountainous regions for example, present challenges to terrestrial microwave installations. However, a significant advantage can be gained using an elevated location. Rather than constructing a tall tower, a microwave communications engineer can take advantage of the mountain elevation.

Weather conditions in mountain locations may lead to significant ice build-up on the many exposed surfaces of a traditional communications tower installation. This ice will significantly impair function initially by impeding radio propagation and eventually causing mechanical damage to the equipment. The present invention solves the problem of ice buildup and wind-loading on the exposed radio gear. The present invention provides a light-weight, integrated radome communications tower that can be preassembled and flown into place, reducing the time and cost of installation.

Many examples of modular, fully composite towers and structures exist. However, no current example defines a tower structure having a shell that exhibits radome properties while also supporting and enclosing an antenna mounting system. For example, there are examples of composite towers that are modular in nature, but are neither easily assembled nor disassembled. Likewise, examples of composite towers do not include towers comprising a radome over the tower, beyond that covering an antenna mounted on the tower. In addition, such composite towers might include a radome that is limited to covering just the portion of an antenna mounting system to which an antenna is mounted, without having the radome cover any additional portion of the antenna mounting system.

In known examples of modular towers with a radome cover at the top of the tower, the antenna mounting structure is typically a substantial, heavy structure employing steel and, often, concrete. In previous tower examples that do describe a fully enclosed system within a tower structure, such as that which utilizes the space inside of the tower to house the equipment including power supply, radios, etc., the tower structure is typically made of materials that are heavy and not amenable to being preassembled and placed into their final location as modular elements.

Antenna towers that are completely covered with radio transparent material presently exist. However, such towers are made of steel with floors inside to house equipment. Those towers are not modular, easily assembled, nor defined as being able to be lifted by helicopter. Furthermore, such towers do not utilize the outer covering to support the antenna mounting system inside.

The presently disclosed communications tower provides a radome covering that structurally supports the mounting system to which antennas are mounted. The antennas are fully enclosed inside the radome. The radome is weather resistant and provides protection to the antenna mounting system, an antenna mounted to the antenna mounting system, and any additional equipment contained within the enclosure formed by the radome. Together the radome covering and mounting system form a single modular unit. Each component on its own, either the radome or the mounting system, would not constitute a tower. However, when these components are integrated along with a base, they form a tower. Using strategic engineering and composite materials, a tower system of the present invention can be made that is sufficiently light enough to be air lifted into place preassembled and full of equipment. This feature in turn eliminates the need to install heavy tower sections and antennas with helicopters one piece at a time, and reduces the assembly steps required for the overall installation. This aspect saves time and money, as well as opens up new markets of service for microwave technologies.

The communications tower disclosed herein is comprised of a base with integral radome outer shell enclosing and supporting an antenna mounting system.

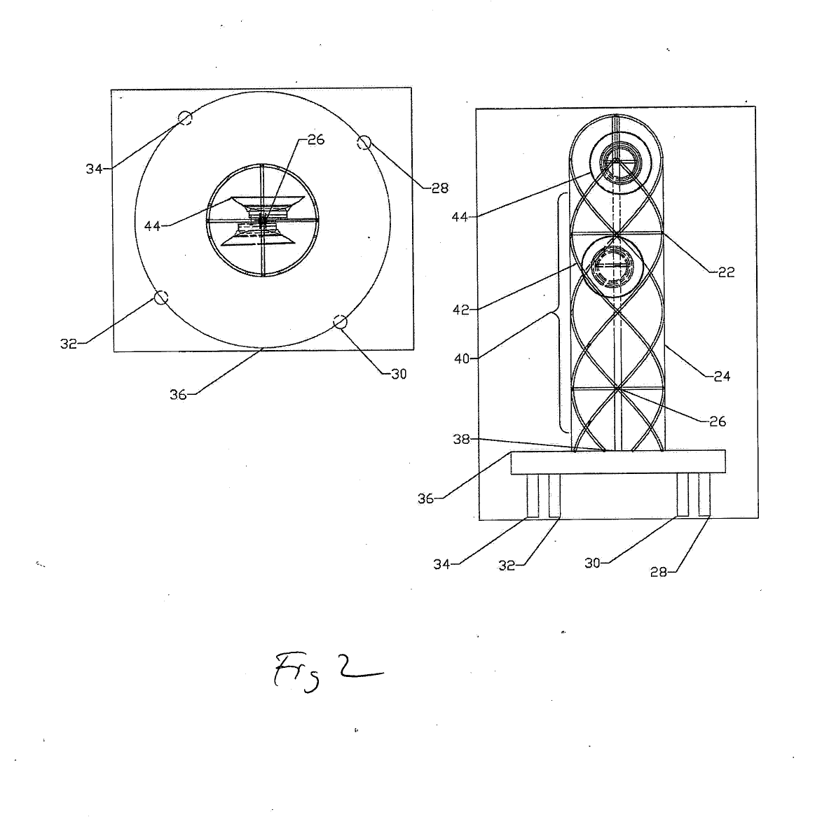

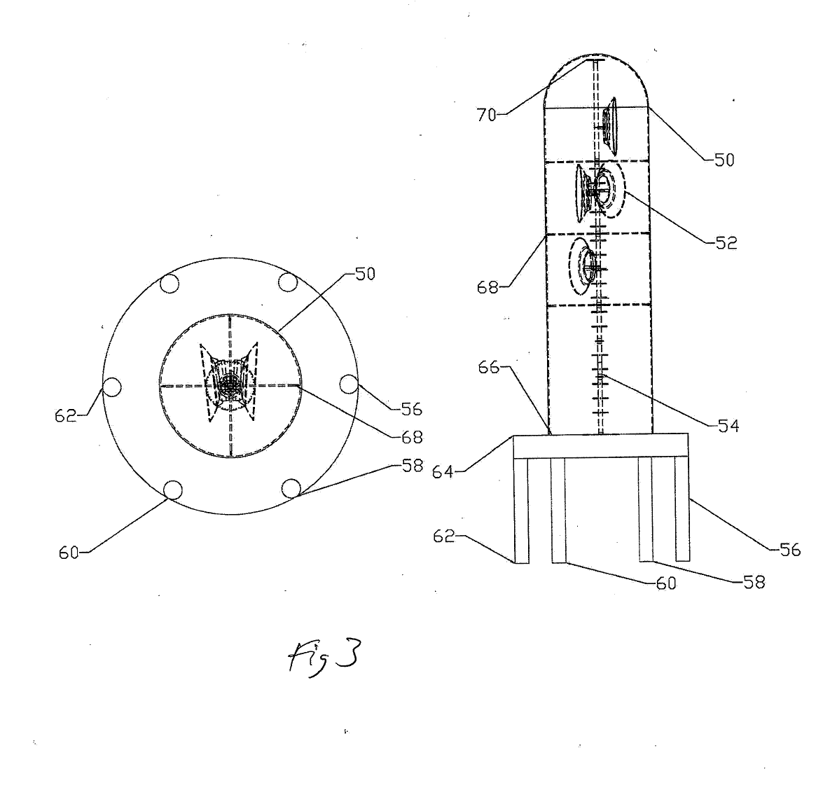

Each piece of the tower is bonded together through appropriate fastening means to maintain a modular, easily assembled system. Examples of appropriate fastening means or methods of bonding include, but are not limited to, bolting, screwing, gluing, clamping, etc. The radome enclosure has a cross-sectional shape that may be circular (as in embodiments shown in FIGS. 2A and 3A), elliptical, or multi sided (having 3 or more sides) in shape. The radome enclosure may be comprised of several sections combined together or one solid shape to form an enclosed space. A key feature of the radome enclosure is that it is an integral piece of the main support for the entire structure while still a modular piece of the system as a whole.

The outer radome enclosure is made either completely or partially of radio transparent material, such that the radome allows flexibility with respect to the placement and number of antennas. The radome may be constructed of any of a number of radio transparent materials commonly used or developed to be radio transparent. Examples of such materials include, but are not limited to, Hypalon® (a registered trademark of Dupont, Wilmington, Del. for chlorosulfonated polyethylene synthetic rubber) and similar elastomers, polymethyacrylate, polycarbonates, fiberglass, etc. The radome enclosure may have a frame that supports a fabric covering, similar to structures commonly used in a tent, where both the fabric and the frame exhibit radome qualities. Alternatively, the radome enclosure may also be solid material which can be assembled together and integrated into the framing members or create the framing members through assembly. The radome enclosure may also be comprised of solid pieces of material like fiberglass, polycarbonate, etc. which are assembled to make a radome covering and frame. [The entire outer structure is a radome to provide flexibility with respect to where and number of antennas can be mounted, correct? We can describe that alternatively, the lightweight shell/enclosure could be made of various materials, with only portions of it being radome/radiotransparent].

The radome shell disclosed herein provides mechanical and load bearing support for the antenna mounting system. The radome enclosure and/or base are bonded to the antenna mounting system by a system of cross members. The cross members may consist of, but are not limited to, line, rope or solid bars. The cross members function to provide integral support that is a part of the structure as a whole and aids in load bearing of the antenna mounting system.

The enclosed antenna mounts of the integrated structure are sufficiently separated from the radome outer shell to create adequate space for mounting and placement of antennas. Accordingly, microwave dishes and antennas of various sizes and shapes can be supported by the enclosed antenna mount system. The sizes of microwave antenna dishes can vary widely, including, but not limited to, antenna dishes having a diameter of 2, 4, 6, 8, or 10 feet and weighing a few lbs to several hundred lbs. For example, an embodiment shown in FIG. 2 contains 8′ microwave dish antennas mounted on an antenna mounting system with an outer radome enclosure. The antenna mounting system will allow for 1 or more antennas that vary in size to be mounted vertically inside of the enclosure formed by the radome shell.

The base may encompass areas for power generation, and equipment storage. It may be comprised of rooms separating the space from the inside of the tower or may simply be the base support for the antenna mounting system and radome shell. The base consists of a structural frame with provisions for a means of anchoring the system in its entirety to the earth or foundation. The base may consist of framing members such as, but not limited to, aluminum I-beams, etc. or may be a solid piece of material such as, but not limited to, carbon fiber plate, etc. The base will contain one or more points of attachment to allow the base to be anchored to a frame, sub frame, or to the earth. The anchoring of the base may be performed by any number of anchors or anchoring means, such as but not limited to, a cable, a cemented rigid element, or a threaded rigid element. The anchor will be mechanically joined to the earth in soil, bedrock, or a combination of soil and bedrock.

The communications tower should be sufficiently light so that it can be easily lifted in sections or as a whole to a remote location by helicopter. The payload limit of helicopters commonly used for construction varies depending upon environmental conditions, height the payload will be lifted to, and other factors. For purposes used herein the payload of a helicopter suited for this application ranges from a payload of 1,000 lbs to 45,000 lbs. A preassembled communications tower full of equipment may weigh as much as 40,000 lbs or an individual section of a tower (to be assembled at a site) may way as little as 500 lbs. Accordingly, the entire structure may be lifted in a single lift, or multiple lifts depending on circumstances.

The light weight of the integrated radome communications tower under certain conditions may permit installation upon anchored elements rather than compacted or poured foundation. The light weight tower therefore does not necessarily require an extensive load bearing foundation. A tower of the as disclosed herein could therefore potentially be anchored directly to bedrock. The disclosed tower may therefore differ from a typical communications tower that needs to be secured to the ground with a significant load bearing foundation, such as one made of pilings and concrete. However, depending upon the actual needs addressed by a given tower and the structural requirement, a tower as disclosed herein could well require a poured foundation. Such a poured foundation in all likelihood would be less substantial, in terms of size and weight, than such a foundation as required for a traditional tower.

The integrated radome communications tower shall be sufficiently strong to support a variety of equipment typically installed on or in a communications tower. Such equipment includes, but is not limited to, antennas, power generation equipment, fuel, batteries, electronics and any other necessary equipment required for remote site operations.

The radome shall be designed to minimize the radio attenuation of the equipment operating inside, while also being structurally strong and proficient in its ability to sustain high winds and severe icing conditions of said remote locations.

The antenna mounting system will include antenna mounts that are of sufficient size and physical dimensions to support any amount of equipment that may need to be installed on them. For example, the mounting system could employ a 6″ pipe that extends vertically within the radome shell and is capable of having an 8′ microwave dish antenna mounted to it. The size of antenna mounts used in the mounting system will be in accordance with the size of mount specified for a particular antenna by the manufacturer of the antenna. For example, a relatively smaller antenna might be in the weight range of about 50 pounds, while a larger antenna could be upward of 600 pounds or more. Accordingly, a mounting system as used herein will be appropriate for the given weight range of antennas and/or equipment to be mounted, ranging from as little as 50 pounds, up to 600 pounds, and covering every variation inbetween, such 100, 200, 300, 400, and 500 pounds. While 50 pounds is an anticipated lower weight and 600 pounds an anticipated upper weight, in practice, the antenna mounting system can be fabricated to employ any material appropriate for any weight to be supported, be the weight to be supported less than 50 pounds (such as 5, 10, 20, 30, or 40 pounds) or in excess of 600 pounds, such as 610, 620, 640, 670, 700, 800, 900, 1000 pounds and upward.

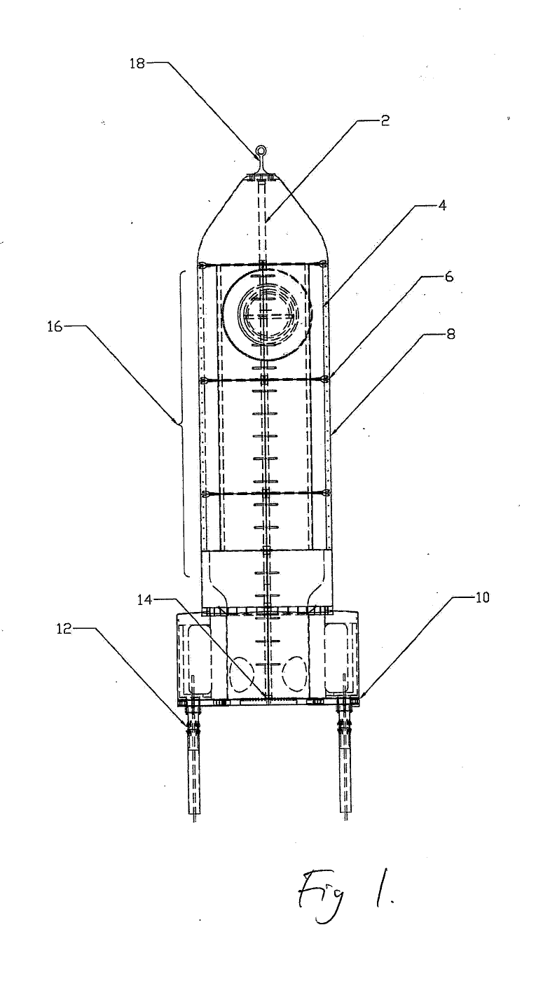

The integrated radome communications tower preferably will incorporate an entrance or a component that can serve as an entrance to allow a person access to the interior of the tower. This access will allow a person to perform inspections, maintenance, adjustments, and so on to equipment and antennas installed in the communications tower. To facilitate inspection, maintenance, and adjusting of mounted antennas and other equipment, the antenna mounting system should incorporate structural elements that permit a person to gain access to the mounted antennas and equipment. For example, the mounting system may include cross member elements on a vertical shaft or mast of the mounting system, such that the cross member elements may function as rungs of a ladder to allow access up the vertical shaft or mast. Examples of such cross member elements or rungs are shown in FIGS. 1 and 3B.

For the purposes of promoting an understanding of the principles of the invention, reference will now be made to the exemplary embodiments illustrated in the drawings, and specific language will be used to describe the same. It will nevertheless be understood that no limitation of the scope of the invention is hereby intended. Any alterations and further modifications of the inventive features illustrated herein, and any additional application of the principles of the invention as illustrated herein, which would occur to one skilled in the relevant art and having possession of this disclosure, are to be considered within the scope of the invention.

The integrated radome communications tower described herein may be configured in any number of designs, such as, but not limited to, those designs shown in FIGS. 1-3.

FIG. 1 shows an embodiment of an integrated communications tower disclosed herein in which a radome frame structure and shell (2) is formed from sectional pieces (8) that are assembled to create the entire radome enclosure. A panel section may include an exterior wall section with flanged edges and containing a bolt patterns to assemble to other sections. The embodiment shown in FIG. 1 also provides an example of integrating individual compartments for storing gear and equipment, in which the components reside between the radome and base of the communications tower. The embodiment in FIG. 1 shows the antenna mounting system (2) as being connected to a bracing system (6) contained in the radome shell or enclosure. In this manner, the interior of the radome shell (8) is connected to the mounting system (2), such that the radome shell provides structural support to the mounting system. The antenna mounting system (2) is also supported by the base of the tower (10) through an antenna mounting system connection (14). As shown in this embodiment, the antenna mounting system (2), radome shell (8) and frame (16), and base (10) are structurally integrated to form the radome communications tower. The embodiment in FIG. 1 demonstrates how an 8′ microwave dish (4) could be housed inside the integrated, overall structure. The base (10) is shown with an anchoring system (12) having a built in leveling system that would allow the anchoring system to be easily installed, without the need for heavy equipment. The lightweight design of the communications tower shown in FIG. 1 allows it to be positioned at its final location site by helicopter. A lifting eye (18) has been incorporated at the top of the tower structure to allow a helicopter to easily rig up the tower and move it to its desired location.

Another embodiment of an integrated radome communications tower disclosed herein is shown in FIG. 2. In this example, the radome frame is formed from a lattice structure comprised of sections of radio transparent bars (42) similar to that commonly used in a tent. This lattice structure is then covered by radio transparent material (40) such as Hypalon, which provides protection from the elements for the equipment and antennas that are housed inside the radome enclosure. The hypalon or similar material would have fasteners built into the fabric for securing the fabric to the lattice structure and to secure it to the base, The antenna mounting system (26) is connected to the frame at intersecting points through a bracing system (22), which also includes structure-supporting cross members. The antenna mounting system is connected to the base through an antenna mounting system connection (38). The base (36) is anchored with an anchoring system (28) which would only require small equipment to install. As shown in this embodiment, the antenna mounting system (26), radome shell (24) and frame (42), and base (36) are structurally integrated to form the radome communications tower. The communications tower shown in FIG. 2 includes 8′ microwave antenna dishes (44) that are mounted on an antenna mounting system (26). The tower structure has a location at the top of the radome enclosure which could incorporate a lifting eye or some other means by which the integrated radome communications tower could be easily rigged and thereby readily moved with a helicopter.

A further embodiment of an integrated radome communications tower presently disclosed is shown in FIG. 3. This embodiment provides an example of a uni-structural, solid radome shell (50) which is connected to a base (64) and houses an antenna mounting system (54). The antenna mounting system (54) is attached to the interior of the radome shell with cross members, which for example can be formed from line, rope or bars (68). The antenna mounting system (54) is connected to the base through an antenna mounting system connection (66). As shown in this embodiment, the antenna mounting system (54), radome shell (50) and base (64) are structurally integrated to form the radome communications tower. The structure is anchored with an anchoring system (56) which is similar to the anchoring systems described in FIGS. 1 and 2. This structure likewise contains a lifting point (70) similar to those depicted in FIGS. 1 and 2 to allow it to be lifted into place as a whole unit with a helicopter.

While this invention has been described as having particular configurations disclosed herein, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A tower comprised of an antenna mounting system, a radome shell, and a base, wherein the radome shell and base support the antenna mounting system.

2. The tower of claim 1, wherein the radome shell and the antenna mounting system form a single modular unit of the tower.

3. The tower of claim 1, wherein the radome shell fully encloses the antenna mounting system.

4. The tower of claim 1, wherein the radome shell provides mechanical and load bearing support for the antenna mounting system.

5. The tower of claim 1, wherein the radome has a cross-sectional shape that is circular, elliptical, or multi sided.

6. The tower of claim 1, wherein the radome shell comprises several sections assembled to form the radome shell.

7. The tower of claim 1, wherein the radome shell is a single piece.

8. The tower of claim 1, wherein the radome shell is weather resistant and provides protection to the antenna mounting system, an antenna mounted to the antenna mounting system, and any equipment contained within an enclosed space formed by the radome shell.

9. The tower of claim 1, wherein the antenna mounting system allows for 1 or more antennas that vary in size to be mounted vertically inside of an enclosure formed by the radome shell.

10. The tower of claim 1, wherein the base comprises one or more points of attachment to anchor the base to a frame.

11. The tower of claim 1, wherein the base comprises one or more points of attachment for anchoring the base to earth.

12. The tower of claim 11, wherein the anchoring is performed by an anchor comprising a cable, a cemented rigid element, or a threaded rigid element, wherein the anchor is mechanically joined with soil, bedrock, or a combination of soil and bedrock.

13. The tower of claim 1, wherein a complete tower having antenna mounting system, a radome shell, and a base is capable of being lifted to a location site by a helicopter.

14. The tower of claim 1, wherein each of the of an antenna mounting system, radome shell, and base are individually capable of being lifted to a location site by a helicopter.

15. The tower of claim 6, wherein each of the sections are individually capable of being lifted to a location site by a helicopter.
